(19) United States
(12) Patent Application Publication
(10) Pub. No.: US 2009/0061943 A1
(43) Pub. Date: Mar. 5, 2009

(54) SYSTEM FOR OBTAINING INFORMATION AND COMMUNICATING USING THE SMS CHANNEL

(76) Inventor: Guy Kamgaing-Kouam, Los Angeles, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/848,568

(22) Filed: Aug. 31, 2007

(51) Int. Cl. H04B 1/38

(52) U.S. Cl. 455/566

(57) ABSTRACT

A system for obtaining information and communicating comprising: a browser for a cell phone; providing a transmission path which at least partially includes the SMS channel; installing the browser on a cell phone; the browser displaying a GUI on the cell phone; a user formatting an query for information; the query being determined in response to entries on the keypad as determined by navigation by the user through the GUI; transmitting the query via the transmission path; obtaining the requested information from a data source; transmitting the information to the cell phone via the transmission path; and displaying the information in the GUI on the cell phone display. The information may be obtained from a local database or from the Internet. The information may be an e-mail message or a portion of an e-mail message. The query may be for transmission of information only when the information changes.

### BACKGROUND OF THE INVENTION

(1) Field of the Invention

The present invention relates to the field of mobile telephony and more particularly to methods for obtaining information and communicating and using the Short Message Service (SMS) channel, which is available on mobile telephones and used for text messaging.

(2) Description of the Related Art

Many people today are intimately familiar with the World Wide Web, otherwise known as the Internet. It is well known that you can retrieve much useful information using a browser and instantaneously communicate with others using e-mail. It is possible to connect with the Internet via wire or wirelessly using a desktop computer a laptop computer and a cell phone. A cell phone can connect to the Internet via a Wireless Access Point (WAP). Other options for phones to access information without a Wireless Access Point (WAP) are:

Unstructured Supplementary Services Data (USSD)—This technology allows users to dial a series of numbers and characters (such as # 101*) and create an over-the-air session with a server, which can display information on the user's phone. This can be used to display text menus, which provide access to services, which can then be selected by the phone user to interactively query the server. USSD sessions last a maximum of two minutes and are generally charged per minute.

For example in the USA, to get balance of minutes with Cingular (now AT&T), users enter #MIN then make a SMS call from their phones.

Push-SMS services—Carriers and third parties offer “push” SMS services that users can opt into. A user will then receive periodic SMS messages with the content that they signed up for, and will be charged either per message or per month.

There are, in addition, a number of services requiring the sending of a pre-assigned SMS to get ringtones, jokes, vote etc.

Subscriber Identity Module (SIM)-card products (SIM Tool Kit)—Some SIM card manufacturers and carriers offer services that reside on the SIM card, not the phone. There are various limitations to applications on the SIM card, most notably the maximum memory space of 64 KB and cost.

One is example, the SIMply® SIM card from Sagem Ora of Paderborn, Germany, contains wireless Internet browser software, which allows the phone to communicate with a gateway with compatible software. The gateway communicates with the internet where content is translated using another special software.

Another example, the SmartáLaCarte™ solution from SmartTrust of Stockholm, Sweden, is a graphical user interface that allows software routines available on a SIM card to be invoked without the need for the end user to be able to do complex programming.

SMS Shortcode Services—Carriers allocate shortcodes (short phone numbers) to various services. An example of this, in the US, is Google, which has a number 46645 (GOOGL). An SMS to this number, using the correct syntax for the Google services, will return the requested information. There are two limitations to these services. First, users have to remember the shortcode to use. Second, users have to remember the exact syntax of the service.

In a blog at http://vinu.wordpress.com/2006/07/31/surfing-the-web-with-sms/, the moderator and a few participants muse about the possibility of using SMS for browsing the web. The moderator states he has created a small Hypertext Preprocessor (PHP) application to allow some basic activities.

There are a number of patents in this area of technology. U.S. Pat. No. 6,947,738 B2 discloses a multimedia messaging system for sending and receiving Multimedia Messaging Service (MMS) messages. The MMS messages are sent to a MMS server and addressed to the recipient's Mobile Subscriber International Subscriber Directory Number (MSISDN). The MMS server sends a notification to a Password Authentication Protocol (PAP) server that sends the notification as a WAP Push to the recipient mobile device telling the mobile device to retrieve the message. If the recipient mobile device is engaged in an on going or dedicated session with the Internet, the notification is sent to the recipient mobile device during the session. The recipient mobile device then initiates a Hypertext Transfer Protocol (HTTP) GET request to retrieve the multimedia message via the voice or data channel of a Public Land Mobile Network (PLMN). If the recipient mobile device is not engaged in an on going or dedicated session with the Internet, the notification is sent to the recipient mobile device as a WAP Push using SMS as bearer via the signaling channel of the PLMN. The recipient mobile device then initiates a HTTP GET request to retrieve the multimedia message via the voice or data channel of the PLMN.

U.S. Pat. No. 7,068,189 B2 discloses an invention for delivering information, such as a notification or other content, to a select communication device when defined event and location criteria are satisfied. A profile is established to define the event and location criteria along with a method for delivering the information. Typically, the receipt of event indicia indicating the occurrence of an event is compared with the event criteria in the profile. When the event indicia satisfy the event criteria, location indicia is gathered and compared with the defined location criteria. Alternatively, a trigger corresponding to location is received and compared with the location criteria before determining whether an event corresponding to the event criteria is satisfied. When both the event occurrence and location indicia match the event and location criteria, the information is sent to the appropriate communication device.

U.S. Pat. No. 7,236,771 B2 discloses a broadcast network in which, to improve network efficiency and quality of service, a particular transmitter within the network is selected to transmit content to a particular, preferably mobile terminal 3. The selection of the transmitter is carried out by reference to information available in a second network, the user of the terminal 3 having a further terminal connected to the second network 27 and either integrated with or in close proximity to their mobile terminal.

U.S. Pat. No. 7,242,925 B2 discloses multiple access Internet portals with wireless to market place systems. A representative system, among others, includes a wireless Internet server and a wireless market place system. The wireless Internet server routes Internet content from a content provider to a plurality of platform gateways, while the wireless market place system receives a set of rules from a third party vendor, and translates the set of rules into a format operable to be routed by the wireless Internet server. Methods and other systems for providing access to wireless customers are also provided.

U.S. Pat. No. 7,248,888 B2 discloses a method and apparatus for providing interactive audience participation at live entertainment events. Enjoyment for a plurality of participants is enhanced. Participants employ wireless interactive devices that present a promotional message and include user input and output interfaces. Participants are queried, and enter answers via the user input interface. The answers are transmitted to a central processor, stored as participant data, and processed into results. A visual display or the user output interface announces the results to the participants.

U.S. Pat. No. 7,249,132 B2 discloses information that is based on a database portion of a first user equipment component. The information is translated from a first database format to a second database format for a download of the information from a network storage component to a second user equipment component. The first database format is understood by the first user equipment component. The second database format is understood by the second user equipment component. The first database format is not understood by the second user equipment component.

U.S. Pat. No. 7,251,452 B2 discloses a system and method, which automatically plays programming selections corresponding to the user's preferences as specified in a playlist. The user can create a playlist and transfer the playlist to a receiver. The receiver scans the content in all of the channels that are being broadcast to the receiver to determine if any of the programming matches the selections on the playlist. If there is a match, the receiver automatically tunes the receiver to the matching program.

There are many cell phone carriers in the world who do not offer Internet access to their cell phone subscribers. Also, there are many people who do not want Internet access via their cell phones. This is primarily because the cost of an Internet query cannot be determined in advance. On the other hand, all cell phone carriers offer SMS. Moreover, the cost of each SMS message is fixed and therefore well known to users. Thus what is needed is a system which allows users to retrieve information from the Internet or other remote databases using the SMS channel.

Development of a system which allows users to request and receive a variety of information from the Internet or another remote database using the SMS channel represents a great improvement in the field of cell phone applications and satisfies a long felt need of the cell phone user.

### SUMMARY OF THE INVENTION

The present invention is a system which allows cell phone users to request and receive a variety of information from the Internet or another remote database using the SMS channel. On a phone outfitted with die browser of this invention, a user's query is translated into an SMS and sent to the Content Server. A reply is immediately generated and sent back to the mobile phone, where the browser formats and displays the response directly on the handset. Since there are so many different makes and models of phone each having different functionalities, operating systems and system performances, the browser of this invention is programmed for every different handset make and model Also, since cell phones are used in so many different countries the browser of this invention is programmed to work in many different languages. The browser uses a simple and intuitive user interface. The Content Server allows access to information from any phone, anywhere, for the cost of an SMS message.

The present invention allows users to: receive and send e-mail; receive and send instant messages; obtain a variety of information from the internet; obtain real time news, weather, stock prices, sports scores, etc.; play games downloaded from the Internet; play interactive and multiplayer games; download accessories for their phones including ringtones and wallpaper. There is no downloadable application that offers the same functionality as this invention over the SMS channel.

The present invention comprises: providing a browser for a cell phone; providing a transmission path which at least partially includes the SMS channel; installing the browser on a cell phone; displaying the GUI on the cell phone; a user formatting an query for information, the query being determined in response to entries on the keypad as determined by navigation by the user through the GUI; transmitting the query via the transmission path; obtaining the information from a data source; transmitting the information to the cell phone via the transmission path; and displaying the information in the GUI on the display.

The information may be obtained from a local database or from the Internet. The information may be an e-mail message or a portion of an e-mail message. The query may be for transmission of information only when the information changes. In this case the query is transmitted once and stored.

This invention further comprises a system for permitting a chat session between a first user on a cell phone and a second user on a computer comprising: providing a chat location for the computer, which may be a web site; allowing the first user to initiate and respond to a chat session with the second user, input being provided by entries on the keypad on the cell phone as determined by navigation by the first user through the GUI; allowing the second user to initiate and respond to a chat session with the first user; the chat being displayed on the GUI on the display and on the monitor of the computer. Many services offer SEND SMS services from the web to a mobile phone. The chat portion of this invention enables the receiver of the message to immediately reply with both messages popping up on the computer screen and the phone.

The pathway may comprise an SMS gateway and a CMS. The SMS query is addressed to the SMS gateway. The SMS query is transmitted to the SMS gateway via a carrier network from where it is passed to the CMS. In the CMS it is translated into query routine. The routine is run to obtain information requested in the SMS query. The information is formatted into an SMS response addressed to the cell phone of the user. The SMS is passed from the CMS to the SMS Gateway and then transmitted to the cell phone via the carrier network. At the cell phone the browser intercepts the SMS response and displays it via its GUI on the phone's display.

The invention further includes a system for updating the browser comprising: determining the version of browser installed on the cell phone when an SMS is received from the cell phone; determining whether the cell phone is GPRS enabled; if available, obtaining a newer version of the browser; if the cell phone is GPRS enabled, transmitting the newer version to the cell phone via a GPRS pathway; if the cell phone is not GPRS enabled transmitting the newer version to the cell phone via the transmission path; and installing the newer version on the cell phone.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is a block diagram illustrating the connectivity of the elements used in this invention.

FIGS. 2A-2E illustrate the Graphical User Interface (GUI) for determining an exchange rate.

FIG. 2A illustrates selecting the Finance icon from the browser main menu.

FIG. 2B illustrates selecting the Currency Exchange icon from the sub menu.

FIG. 2C illustrates selecting a specific currency conversion.

FIG. 2D illustrates approval of the charge for the query.

FIG. 2E illustrates presentation of the response in the cell phone display.

FIGS. 3A-3D illustrate the GUI for playing a game.

FIG. 3A illustrates selecting the Games icon from the browser main menu

FIG. 3B illustrates selecting a specific game icon from the sub menu

FIG. 3C illustrates approval of the charge.

FIG. 3D illustrates presentation of the game in telephone display.

FIGS. 4A-4E illustrate purchase of a ringtone.

FIG. 4A illustrates selecting the Music icon from the browser main menu.

FIG. 4B illustrates selecting the Ringtone icon from the sub menu.

FIG. 4C illustrates selecting the desired ringtone.

FIG. 4D illustrates approving the charge.

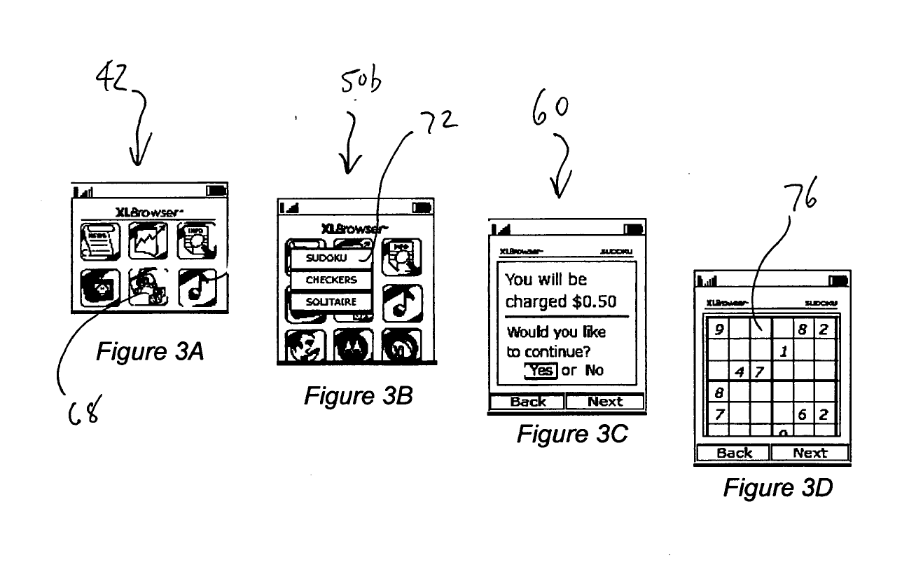

FIG. 3E illustrates notification of receipt of the ringtone by the phone.

FIG. 5 is a flowchart showing processing of a request for weather information, which is retrieved from the Internet.

FIG. 6 is a flowchart illustrating processing of a sports score alert.

FIG. 7 is a flowchart illustrating a chat session.

FIG. 8 is a flowchart illustrating browser software update.

FIG. 9 is a flowchart illustrating e-mail communication.

FIG. 10 is a flowchart illustrating processing a request for the joke of the day, which is stored on a local database.

FIGS. 11A-11E illustrate the Graphical User Interface (GUI) for placing a request for sports alerts.

FIG. 11A illustrates selecting the Alerts icon from the main menu.

FIG. 11B illustrates selecting the Sports Score icon from the sub menu.

FIG. 11C illustrates selecting teams for which alerts are desired.

FIG. 11D illustrates approval of the charge for the query.

FIG. 11E illustrates display of the result on the phone display.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

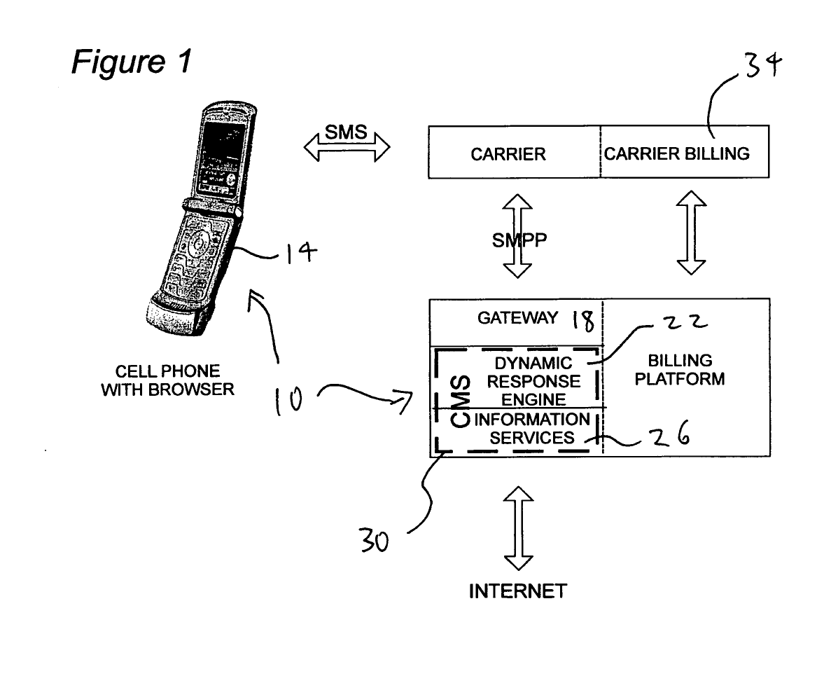

FIG. 1 shows the four high-level elements of this invention 10. These are: the Invention browser 14, which is installed on a user's cell phone; the SMS Gateway 18; the Dynamic Response Engine 22; and Information Services 26. The Dynamic Response Engine 22 and Information Services 26 are contained in the Content Management System 30 (CMS). FIG. 1 also shows how this invention interfaces with Carrier Billing 34.

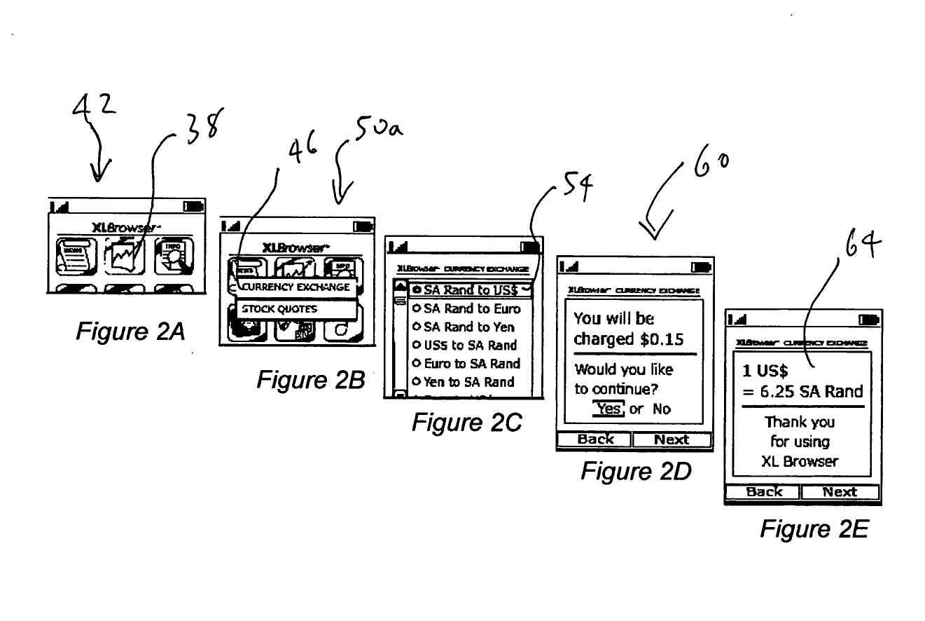

FIGS. 2A-2E show the menus for determining an exchange rate. FIG. 2A shows selecting the Finance icon 38 from the browser main menu 42. FIG. 2B shows selecting the Currency Exchange box 46 from the sub menu 50a. FIG. 2C shows selecting a specific currency pair 54 for which conversion is desired. FIG. 2D shows approval of the charge 60 for the query. FIG. 2E shows presentation of the response 64, the desired currency conversion in the phone's display. Information flows similarly to the flow shown in FIG. 5.

FIGS. 3A-3D show the menus for playing a game. FIG. 3A shows selecting the Games icon 68 from the browser main menu 42. FIG. 3B shows selecting a specific game box 72 from the sub menu 50b. FIG. 3C shows approval of the charge 60. FIG. 3D shows presentation of the game 76 in phone's display. Information flow is similar to that shown in FIG. 10.

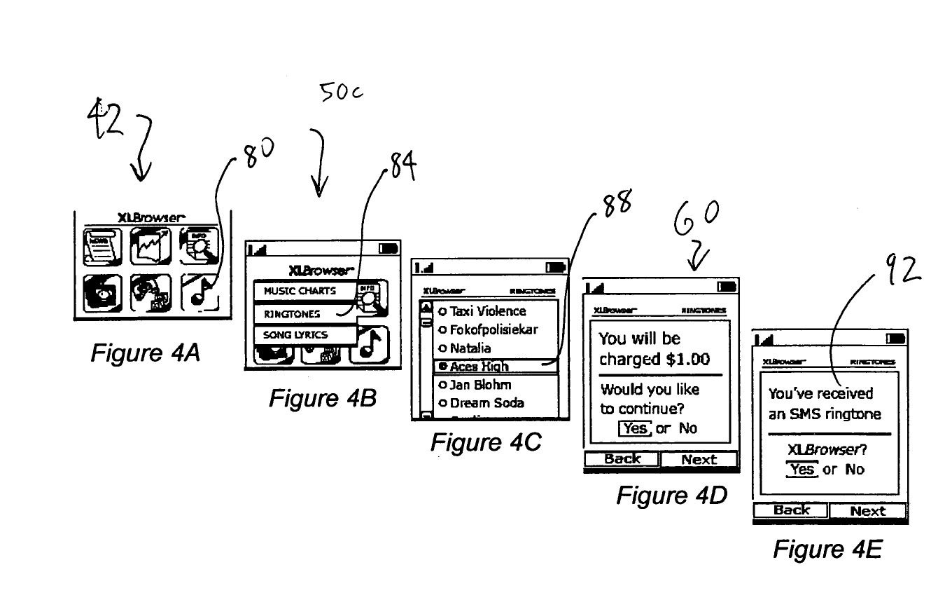

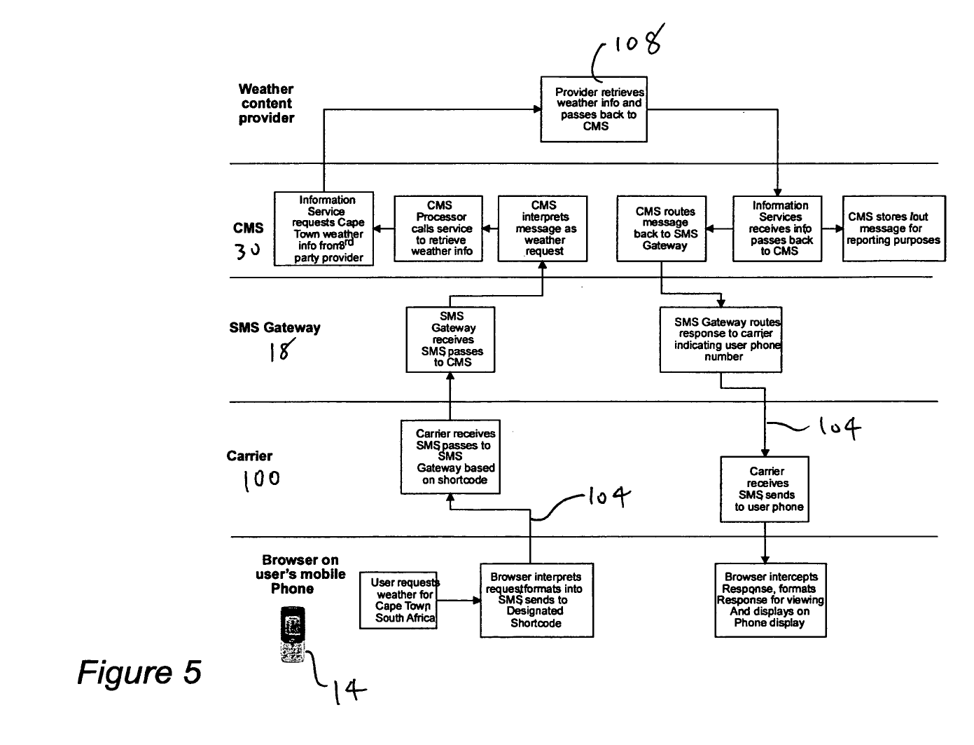

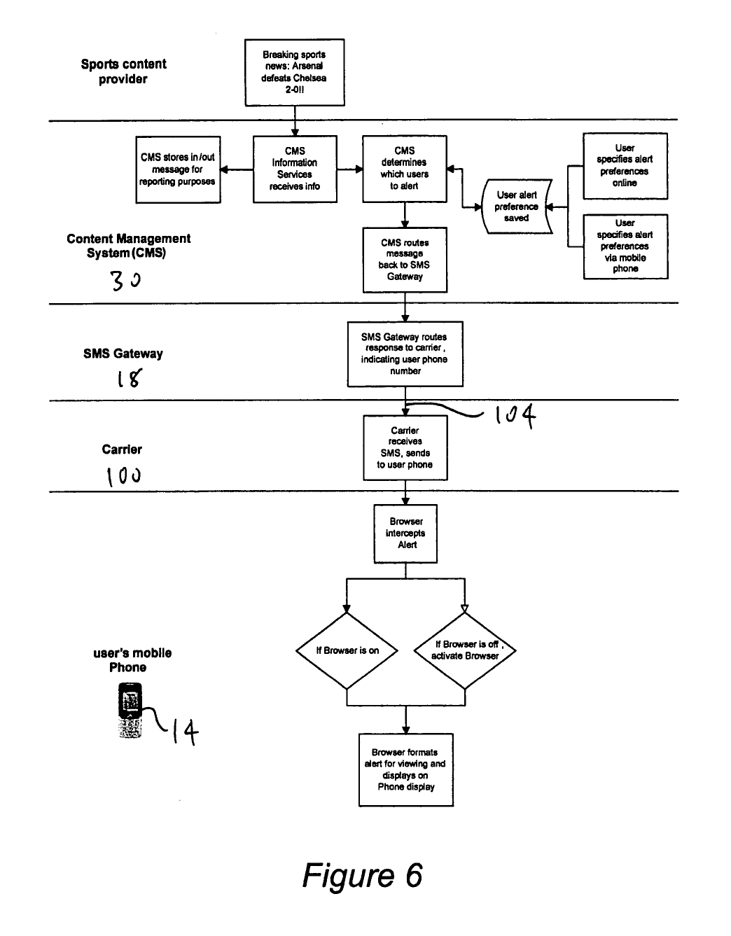

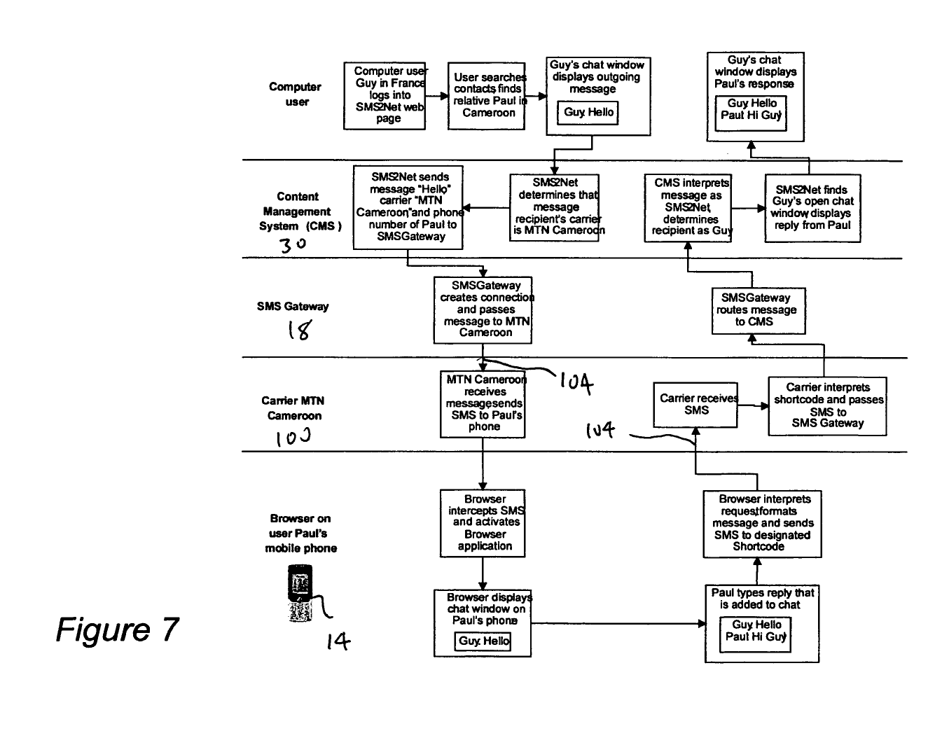

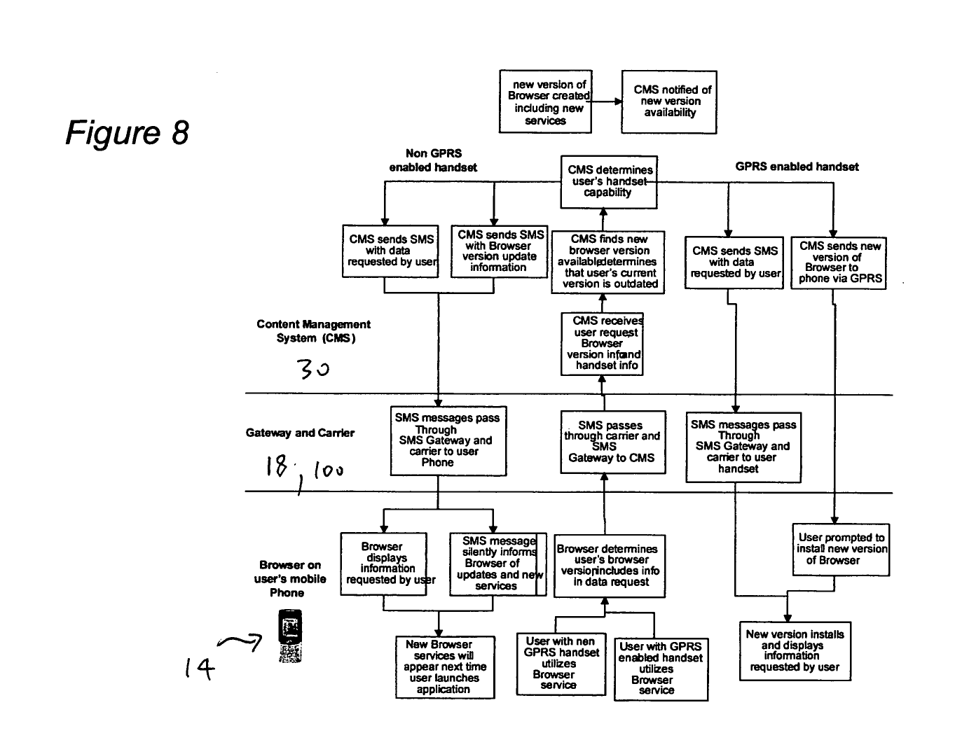

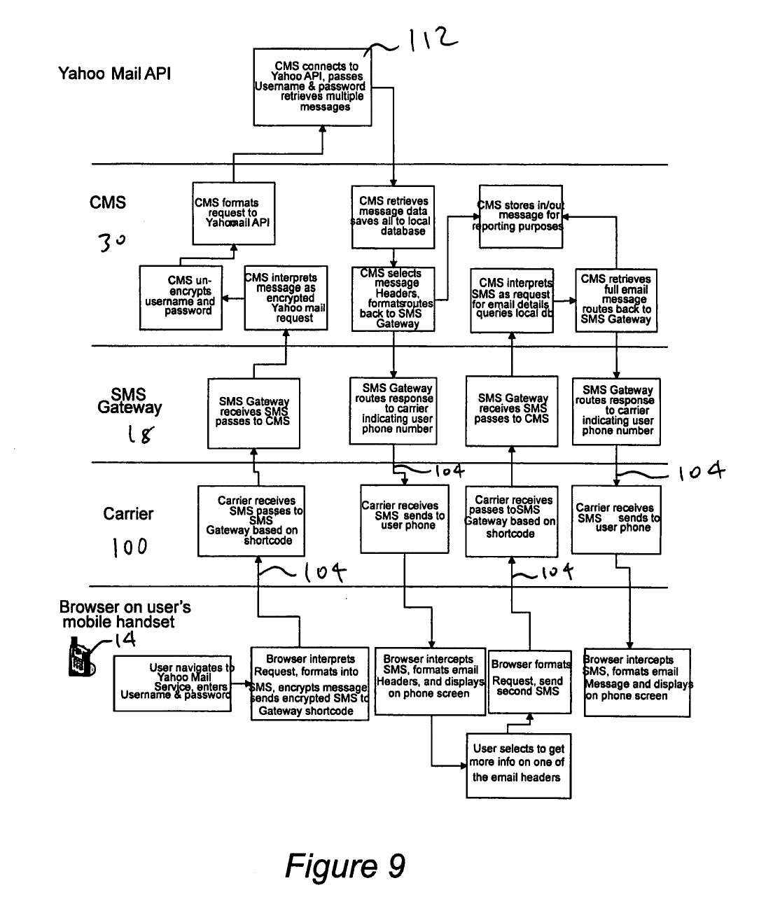

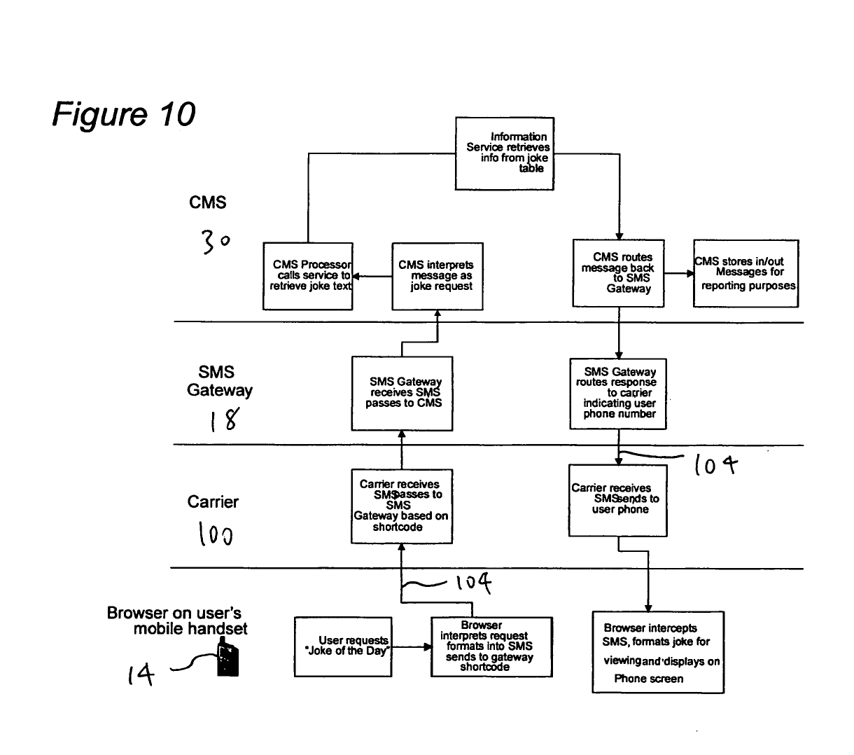

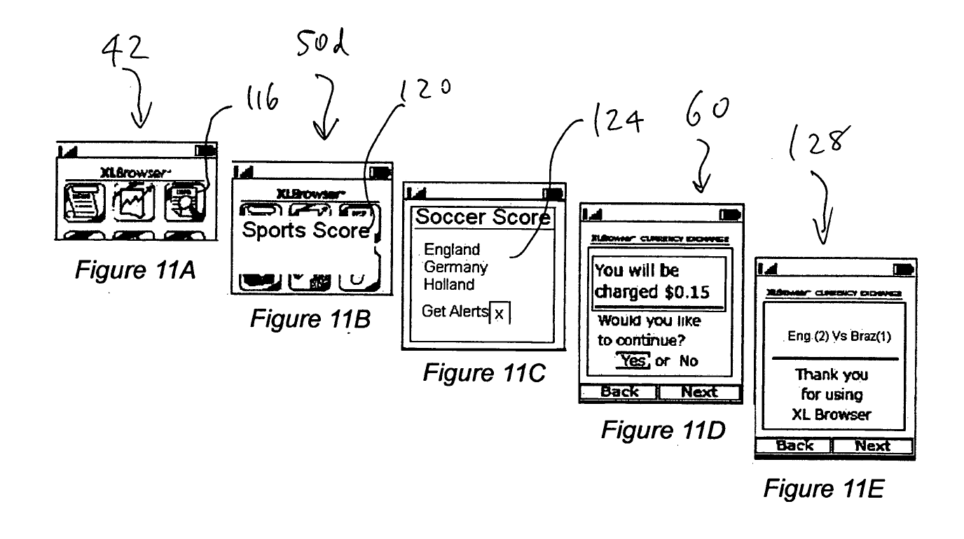

FIGS. 4A-4E show the menus for purchase of a ringtone. FIG. 4A shows selecting the Music icon 80 from the browser main menu 42. FIG. 4B shows selecting the Ringtone icon 84 from the sub menu 50c. FIG. 4C shows selecting the desired ringtone 88. FIG. 4D shows approving the charge 60. FIG. 4E shows notification 92 of receipt of the ringtone by the phone. Information flow is similar to that shown in FIG. 10.

Similar menu systems are provided for other services provided by the system of this invention.

FIG. 5 illustrates how this invention 10 obtains information for a user of a cell phone 14 (mobile phone or hand set). In the example shown on FIG. 5, the request is for the weather in Cape Town, South Africa. It will be readily understood that the cell phone 14, as is typical of all cell phones, has a keypad and a display. First a special browser is provided for the phone, which is installed in the phone's memory. Among other capabilities, the browser allows a user to navigate a specially designed GUI, examples of which are shown in FIGS. 2A-4E and 11A-11E which includes a main menu 42 and at least one submenu 50. The user presses appropriate keys on the keypad in order to enter information as the GUI presents the various menus and submenus.

As the user navigates the GUI and formulates his request, the browser formats an SMS query for the information, which is necessarily a short message since SMS messages can only be of a limited length. When the user has navigated to the end of the input screens, the SMS message, which is addressed to the invention's SMS gateway 18, is transmitted. First the SMS message is transmitted to the network of the cell phone carrier 100 via the SMS channel 104. When the carrier 100 determines that the message is for the SMS gateway, it transmits it to the gateway 18. The gateway 18 then passes the message to the CMS 30.

In the CMS 30 an interpreter determines what the query is and launches the appropriate series of operations (routine) to be performed by the computer. If the desired information is stored on a database within the CMS, the routine is programmed to obtain the desired information from that database. If the information is available from the Internet, the routine is programmed to visit the appropriate web site and extract the appropriate information from it.

In the example shown in FIG. 5, the SMS query could be something as simple as “WEATHER, Cape Town, South Africa”. When it reaches the CMS 30 it will be translated into a routine which visits a weather web site 108 and extracts current weather information from it for Cape Town, South Africa.

The extracted information is then passed back to the CMS 30. Input and output messages are also stored in the CMS 30 for reporting purposes. From this the routine constructs a reply SMS message, addressed to the cell phone 14. This reply message is routed back to the cell phone via the SMS gateway 18 and the carrier's SMS channel 104 to the cell phone 14.

From the above it can be seen that a special transmission path for the cell phone 14 is provided in which part of the transmission path is the SMS channel 104.

At the cell phone 14, the browser intercepts the SMS message and determines that it is a browser SMS message and not a text message from another source. The browser then displays the desired information in the GUI on the display. See, for example, FIG. 2E.

FIG. 6 illustrates a variation on this invention in which the query is submitted only once and is stored on the CMS 30. Then, any time the desired information becomes available or changes, the reply message is sent to the cell phone 14. FIG. 6 illustrates this with a request for a soccer score. The user had previously submitted a request to be notified (an alert) when a particular soccer game had ended. This was stored in the CMS 30. Then when the game ends, the final score is transmitted to the cell phone.

This Figure illustrates another feature of this invention. If the browser is off when the alert is received, the browser is activated in order to display the alert.

FIG. 7 illustrates that this system can additionally be used for permitting a chat session between a first user on a cell phone and a second user on a computer. Chat can refer to any kind of communication over the Internet, but is primarily meant to refer to direct, one-on-one or group, text-based communication, using tools such as instant messaging and Internet Relay Chat (IRC). A chat facility, including a chat window which is displayed on the computer monitor, must be provided for the computer. This can be in the form of a web site. The invention's browser includes a special chat window for display on the phone. The phone user makes input using the keys on the phone keypad. The computer user makes input using the computer keyboard or using voice recognition software. This allows the users to chat with each other, with both their inputs being displayed in their respective chat windows. If either user is not immediately available, the chat messages will be stored until either or both of them come back on line. In the case of the phone user, the message will be stored in the phone's inbox. After they both come back on line, the chat session will proceed.

FIG. 8 illustrates how the browser is updated. This procedure is automatically performed any time the system receives a query from cell phone 14. The SMS query message is additionally coded with the browser version and the cell phone capabilities. When the CMS receives this message, it compares the browser version on the cell phone with the current browser version. If a new version is now available it transmits the new version to the cell phone 14. If the cell phone is General Packet Radio Service (GPRS or Internet) enabled, the system transmits the new version to the cell phone via GPRS. If the cell phone is not GPRS enabled, the system transmits the new version to the user via the SMS channel 104. After the new version has been fully downloaded to the handset 14, it is installed. Downloading and installation are carried out in the background so the user can carry on with other tasks and not be disturbed by this process.

FIG. 9 is a flowchart illustrating e-mail communication. The user navigates to the Yahoo!® message service screen on the GUI, and enters his username and password. The browser interprets the request, encrypts the username and password and formats it into an SMS, which is addressed to the invention's SMS gateway 18. First the SMS message is transmitted to the cell phone carrier 100 via the SMS channel 104. When the carrier determines that the message is for the SMS gateway 18, it transmits it to the gateway 18. The gateway 18 then passes the message to the CMS 30.

In the CMS 30, the message is interpreted as a Yahoo!® e-mail request. Then the routine unencrypts the username and password and formats a Yahoo!® e-mail request API. This is sent to Yahoo!® mail 112 via the Internet, where e-mail messages for the user are retrieved.

The extracted e-mail messages are then passed back to the CMS 30, where they are stored. The CMS 30 selects the e-mail message headers, formats them into an SMS message addressed to the user and routes them back to the gateway 18. Input and output messages are also stored in the CMS 30 for reporting purposes. This reply message is routed back to the cell phone via the SMS gateway 18 and the carrier's SMS channel 104 to the cell phone 14.

At the phone 14 the browser intercepts the SMS message and displays it on the phone's screen. The user sees a number of e-mail message headers. If the user wishes to get more information about one particular e-mail he has the option to select it. The browser interprets this request and sends a second SMS back through the carrier's SMS channel 104 and the gateway 18 to the CMS 30 in a process that is similar to the process used for the first SMS request. The CMS 30 receives this request and retrieves the full e-mail message, which is now stored locally within the CMS 30. Again input and output messages are stored for reporting purposes. Finally, the CMS 30 routes the full e-mail message back to the user's phone via the gateway 18 and the carrier's SMS channel 104 where the browser intercepts and displays it.

Of course FIG. 9 is just one example. The invention 10 will work with any e-mail provider such as Hotmail (from Microsoft®) and gmail (from Google™).

FIG. 10 is a flowchart illustrating processing a request for the “joke of the day”, which is stored on a local database. When the user has navigated to the end of the input screens, the SMS message, which is addressed to the invention's SMS gateway 18, is transmitted. First the SMS message is transmitted to the cell phone carrier 100 via the SMS channel. When the carrier determines that the message is for the SMS gateway 18, it transmits it to the gateway 18. The gateway 18 then passes the message to the CMS 30.

In the Example shown in FIG. 10, in the CMS 30 an interpreter determines that the request is for the “joke of the day” and launches the appropriate series of operations (routine) to be performed by the computer. In the example shown in FIG. 10, the SMS query could be something as simple as “JOKE”. When it reaches the CMS 30 it will be translated into a routine which extracts the current joke from the database within the CMS 30.

The extracted information is then passed back to the CMS 30. Input and output messages are also stored in the CMS 30 for reporting purposes. From this the routine constructs a reply SMS message, addressed to the cell phone 14. This reply message is routed back to the cell phone via the SMS gateway 18 and the carrier's SMS channel 104 to the cell phone 14.

FIGS. 11A-11E show the menus for placing a request for sports alerts. FIG. 11A shows selecting the Alerts icon 116 from the browser main menu 42. FIG. 11B shows selecting the Sports Score box 120 from the sub menu 50d. FIG. 11C shows selecting teams 124 for which alerts are desired. FIG. 11D shows approval of the charge 60 for the query. The alert request is stored in the CMS 30 memory and the requested information is downloaded every time new information becomes available. FIG. 11E shows display of the result 128 on the phone display. Information flows as shown in FIG. 6.

This invention 10 can be written in any mobile programming language that is compatible with a phone operating system, including Java, C++, C#, and Linux. The functionality and design of this invention is customized for each specific make and model of handset 14. The features available, depending on the capabilities of the handset 14, include the following:

Information Services—The user can request various types of information by using various methods of input including menus, text boxes, dropdowns, and multiple-choice textboxes, which are built into the browser. Example interfaces are shown on FIGS. 2A-4E and 11A-11E. The information retrieved is real-time data. Examples of services available are Translation, Weather Reports, Stock Prices, Horoscope, and Sports Scores. Examples of information flow are shown on FIGS. 5, 6, 7 and 10.

SMS2Net-SMS2Net is a chat feature between a handset with this invention installed and a user on a computer. In computer terms, a chat is a synchronous exchange of remarks over a computer network. The chat window on the phone is formatted like a simplified Instant Messenger, with a chat transcript on the screen that dynamically updates for each new message. The chat window on the computer is also like Instant Messenger, with a contact list, history of Inbox/Outbox messages, and capability to maintain multiple chat sessions. This is illustrated in FIG. 7.

Airtime Services—A user can request to view their airtime credit remaining on their prepaid account, transfer airtime to another user, or purchase additional airtime with a prepaid card. The information is displayed on the phone's screen by the browser. These services are graphical and menu-based, eliminating the need to remember an access code.

SMS interception—This invention 10 can intercept a reply SMS before it reaches the SMS Inbox on the phone, and display the information directly on the phone's display screen.

Remote invocation of the browser—When a message is sent from the SMS Gateway 18 to a phone and the browser is not currently being accessed; the SMS can include a command to the phone 14 to initiate the browser of this invention 10. Once the browser is running, the browser can display the message directly on the phone screen.

Save and retrieve contacts—A user can back-up their contact names and phone numbers to a server, and can then retrieve the contact list any time on their phone 14 or on a computer.

Multiple simultaneous messages—The browser of this invention supports multiple messages coming to the phone 14 at once. The user is given the option to cycle between the various messages.

Store messages in memory—The browser of invention can store response messages on the phone's memory, either persistent (permanent) or in the temporary cache. This enables a user to view a message history.

Request caching (Favorites)—The user can save requests that he uses frequently, for easier access. Examples of this would be Johannesburg weather, IBM stock price, or Arsenal soccer scores, or request for e-mails.

Interactive services—A user can request information, and once the information is displayed on his phone, he can navigate further based on that information. Two examples of this interactivity are: a user requests news headlines, then selects one of the headlines to read the full story; or a trivia contest, where the user receives a question and can reply with an answer

Multimedia—A user can request ringtones, games, wallpapers, or MMS messages through the browser of this invention, and they will be sent to the phone.

USSD—This invention can make USSD calls and open a USSD session with a server, allowing the browser of this invention to include any features or services currently offered by USSD.

General Packet Radio Service (GPRS)—This invention can send and receive information via GPRS, allowing value-added services that depend on GPRS technology to run within the browser of this invention.

SMS Gateway—The SMS Gateway 18 is connected to the Short Message Service Center (SMSC) of numerous carriers. The SMS sent from a phone 14 to the phone number or shortcode associated with the gateway 18 is received by the SMSC 104 of the carrier 100, which then passes the SMS to the SMS Gateway 18. The connection between the SMSC 104 and the SMS Gateway uses various protocols, depending on the carrier's implementation needs.

When the SMS Gateway 18 receives a message, it routes the text of the message to the Content Management System (CMS) 30 for processing. Outgoing messages are sent from the CMS 30 to the SMS Gateway 18, which connects to the carrier 100 to send the SMS back to the cell phone 14. Multimedia files are sent via a Multimedia Gateway connection with the carrier's MMSC, with the same concept as the SMS Gateway 18.

CMS—The CMS 30 contains the following elements:

SMS Gateway connection—This connection passes information back and forth between the CMS 30 and the SMS Gateway 18. The information passed can include message text, user phone numbers, multimedia files, version information, and handset commands.

Content storage—The CMS 30 stores content that does not need to be obtained from a dynamic information service. This includes: ringtones, wallpapers, games, and static text content.

Invention versioning—The CMS 30 maintains information about the current version of this invention 10, with the locations of the newest versions for every handset make and model. This allows the CMS 30 to check for updates and easily send an update to the user.

Information Services Processor—The Processor 22 receives messages from users, requesting different services. The Processor 22 then determines which Information Service 26 to call for each message, and requests and receives information from the proper service.

Message History—The CMS 30 stores all incoming and outgoing messages. This history is used for reporting, billing, and reconciliation purposes, primarily with carriers 100.

Information Services—This invention services request information from a number of sources. The Processor 22 within the CMS 30 calls the relevant service to retrieve information. These information services include:

Third-party service providers—This invention uses Application Programming Interfaces (APIs) of third-party content providers to access their content. The method of access varies by content provider. (example: Weather)

Web page scripting—For some information requests, there is no content provider who has an API to access the content, but it is available on a web page. In this case, a script or ringtone accesses the HTML code of the web page to find the requested information. (example: South African Airways flight status)

Real Stream System (RSS) feeds—An RSS feed pushes updates from a content provider to the CMS's feed reader as they occur. The content is then stored locally, to be returned for any user requests. (example: CNN News headlines)

Manually-entered content—The only source of some local content is manual input. A local source manually enters information into a Web form, which is then able to be retrieved by the CMS Processor. (examples: local bar and club events, or jokes)

This invention 10 uses a graphical icon-based interface to approximate the user interface of a phone's graphical menu, and is extremely easy to learn and use. Having the browser directly on the phone 14 also encourages use and does not require the user to understand how to access the service (as in USSD) and remember complex commands.

In addition, the browser of this invention 10 can be upgraded to improve current services or add new services, and the user will then have access to the new services either with the current version or an upgraded version. This invention 10 allows for access to information services without opting in to a usage contract that push SMS services provide. It also allows for users to access whatever information they want, at any time.

This invention 10 was created to allow any phone 14, over any mobile network, to access real-time information, people and other valuable utilities services. There is a huge and growing divide between users of sophisticated 3G networks who have access to services such as WAP, and users of phones with the basic capabilities of phone calls and text messages. This invention aims to bring the second group closer to the first.

This invention 10 includes a graphical menu-based browser and allows mobile phone users to access a number of services, which can be queried to request information. The browser of this invention 10 is programmed for every different handset make and model and to work in many different languages. Briefly, a message is sent to a server via SMS which translates the message into a query, retrieves the requested information, and sends the message back to the phone via SMS, for display to the user. In addition, on higher-end phones, this invention can be used to retrieve multimedia content, such as ringtones, games, or wallpapers with or without advanced data features on the handset.

The following reference numerals are used on FIGS. 1 through 11E:
10 This invention
14 Cell phone with browser installed
18 SMS Gateway
22 Dynamic Response Engine
26 Information Services
30 Content Management System
34 Carrier billing
38 Financial icon
42 Main menu
46 Currency Exchange Box
50a Currency Exchange Sub Menu
50b Game Sub Menu
50c Ringtone Sub Menu
50d Sports Alert Sub Menu
54 Currency Conversion Selection
60 Charge approval screen
64 Display of currency conversion reply
68 Games icon
72 Game selection box
76 Game display
80 Music icon
84 Music selection box
88 Ringtone selection
92 Notification of receipt of ringtone
100 Carrier
104 SMS Channel
108 Content provider
112 E-mail provider

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A system for obtaining information comprising the steps of:
a) providing a browser for a cell phone; said cell phone having a display and a keypad; said browser including a GUI which may be displayed on said display; said GUI including a main menu and a submenu navigable by entries on said keypad;
b) providing a transmission path for said cell phone; part of said transmission path being an SMS channel;
c) installing said browser on a cell phone;
d) displaying said GUI on said cell phone;
e) formatting an query for said information; said query being determined in response to entries on said keypad as determined by navigation by a first user through said GUI;
f) transmitting said query via said transmission path;
g) obtaining said information from a data source;
h) transmitting said information to said cell phone via said transmission path; and
i) displaying said information in said GUI on said display.

2. A system as claimed in claim 1 in which said data source is a locally stored database.

3. A system as claimed in claim 1 in which said data source is data stored on the Internet.

4. A system as claimed in claim 1 in which said information is an e-mail message.

5. A system as claimed in claim 1 in which said query is saved and steps f) through i) are carried out when said information changes.

6. A system as claimed in claim 1 further comprising the steps of:
a) providing a chat means for a computer;
b) allowing said first user to initiate and respond to a chat session with a second user; said second user being on a computer; input to said cell phone being provided by entries on said keypad as determined by navigation by said first user through said GUI;
c) allowing said second user to initiate and respond to a chat session with said first user; and
d) said chat being displayed on said GUI on said display and on the monitor of said computer.

7. A system as claimed in claim 6 in which said chat means is a web site.

8. A system as claimed in claim 1 further comprising the steps of:
a) providing an SMS gateway;
b) providing a CMS;
c) addressing said SMS query to said SMS gateway
d) transmitting said SMS query to said SMS gateway via a carrier network;
e) passing said SMS query to said CMS;
f) expanding said SMS query into query routine in said CMS;
g) running said routine to obtain information requested in said SMS query;
h) formatting said information into an SMS response addressed to said cell phone;
i) passing said SMS response from said CMS to said SMS Gateway;
j) transmitting said SMS response to said cell phone via said carrier;
k) intercepting said SMS response by said browser; and
l) displaying said SMS response in said GUI on said display.

9. A system as claimed in claims 1 further comprising the steps of:
a) determining the version of browser installed on said cell phone when an SMS is received from said cell phone;
b) determining whether said cell phone is GPRS enabled;
c) if available, obtaining a newer version of said browser;
d) if said cell phone is GPRS enabled, transmitting said newer version to said cell phone via a GPRS pathway;
e) if said cell phone is not GPRS enabled transmitting said newer version to said cell phone via said transmission path; and
f) installing said newer version on said cell phone.
